(19) United States
(12) Patent Application Publication
(10) Pub. No.: US 2006/0213336 A1
(43) Pub. Date: Sep. 28, 2006

(54) Screwdriver handle structure

(76) Inventor: Hung-ming Hu, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/088,733

(22) Filed: Mar. 25, 2005

(51) Int. Cl. B25B 23/16; B25G 1/08

(52) U.S. Cl. 81/177.4; 81/439; 81/490

(57) ABSTRACT

A screwdriver handle structure includes a handle having a storage compartment. The compartment comprises a number recesses to store screw heads therein. The handle is provided with a locator having a trough to receive an engaging device therein. The handle further comprises sliding sections to secure a sliding cover thereon in order to store screw heads.

### BACKGROUND OF THE INVENTION

1. Field of the Invention

This invention relates to a screwdriver handle structure, and more particularly to a handle having a compartment with a sliding cover to store screw heads in the compartment.

2. Description of the Prior Art

A conventional screwdriver bears only one head, which is not convenient to a user. Thus a screwdriver with exchangeable head was derived. The screw heads may be exchanged to different purposes, however, due to the compact sizes of the screw heads, they may be lost accidentally. Therefore, a screwdriver with a storage compartment in the handle was derived, as shown in FIG. 4, which comprises a front handle body A. A compartment A1 is formed in the front handle body A to receive a rear handle body A2 which comprises a number of recesses A3 to store screw heads B. This design adds a rear handle body in order to store screw heads B, which increases the cost and makes the handle heavier.

### SUMMARY OF THE INVENTION

It is the primary objective of the present invention to provide a screwdriver handle structure, which comprises a compartment with a sliding cover to store screw heads therein.

It is a further objective of the present invention to provide a screwdriver handle structure, which modifies the original handle to add a storage compartment without adding any extra parts nor does it change the shape.

It is another objective of the present invention to provide a screwdriver handle structure, which is easy to operate and is cost-effectiveness.

### BRIEF DESCRIPTION OF THE DRAWINGS

FIG. 1 is an exploded view of the present invention;

FIG. 2 is a side view of the present invention with partial sectioned;

FIG. 3 is a view similar to FIG. 2 in an open status; and

FIG. 4 is an exploded view of a prior art.

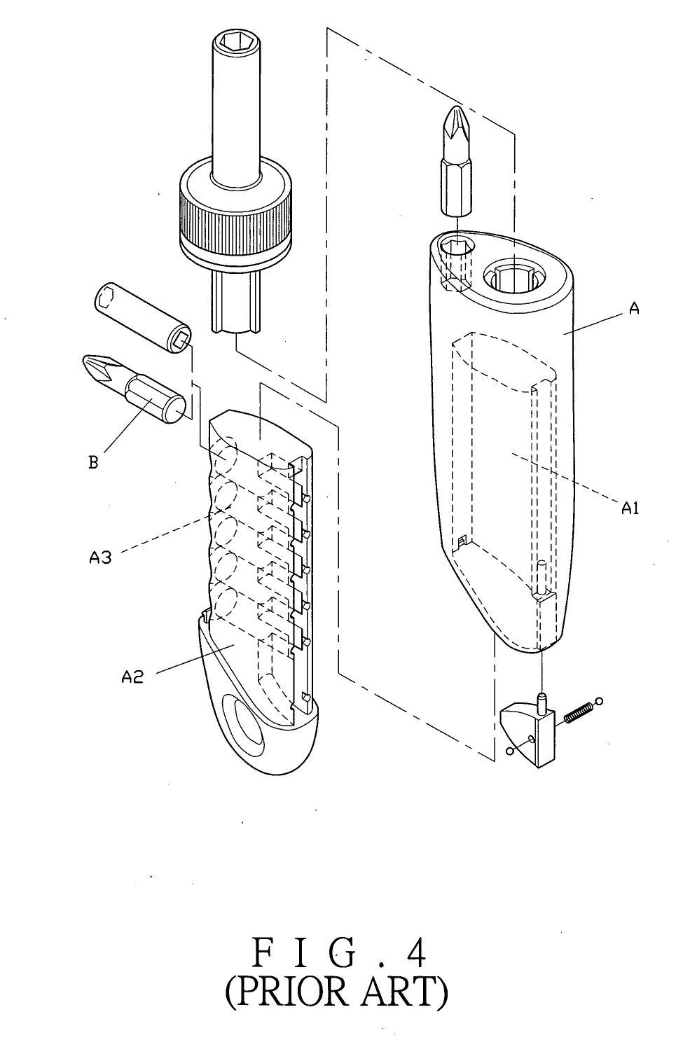

### DETAILED DESCRIPTION OF THE PREFERRED EMBODIMENT

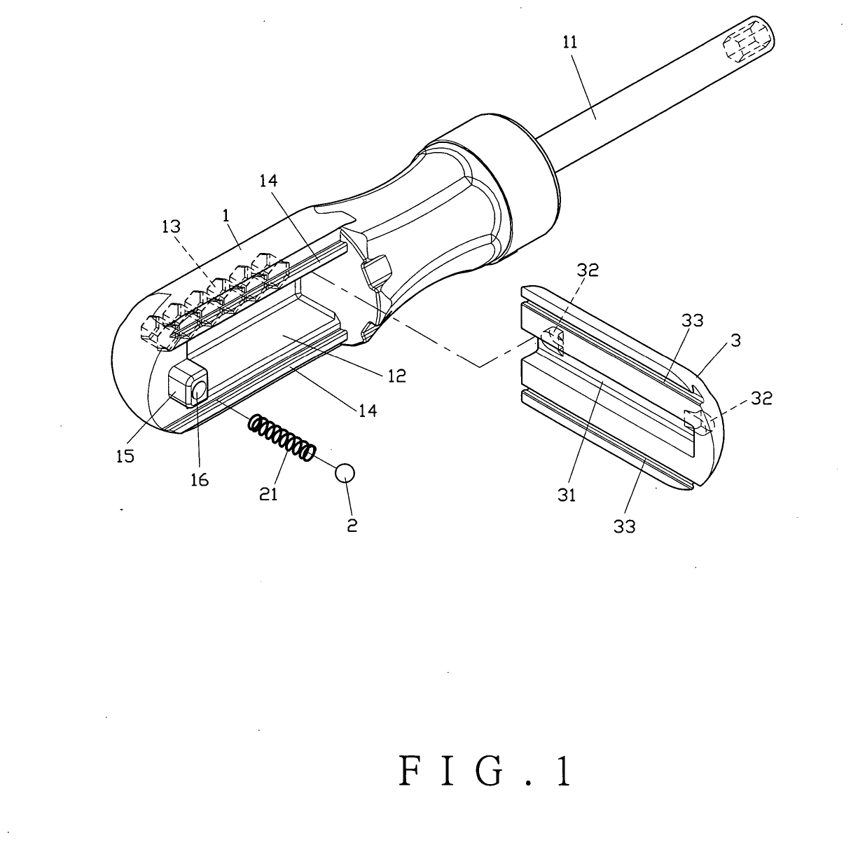

As shown in FIG. 1, the present invention comprises a handle 1, an engaging device 2, and a sliding cover 3.

The handle 1 comprises a sleeve 11 at the front end and a storage compartment 12 within the handle 1. The compartment 12 comprises a number of recesses 13 therein. A pair of sliding sections which can be sliding strips 14 are formed on respective sides of the compartment 12. A locator 15 having a trough 16 is formed on one end of the handle 1.

The engaging device 2 is placed in the trough 16. The engaging device 2 is a bead with an elastic element 21 seating underneath.

The sliding cover 3 comprises a sliding trough 31 on the inner edge with a pair of locating holes 32 at respective ends of the trough 31, and a pair of sliding sections which can be sliding channels 33 to be meshed with the sliding strips 14.

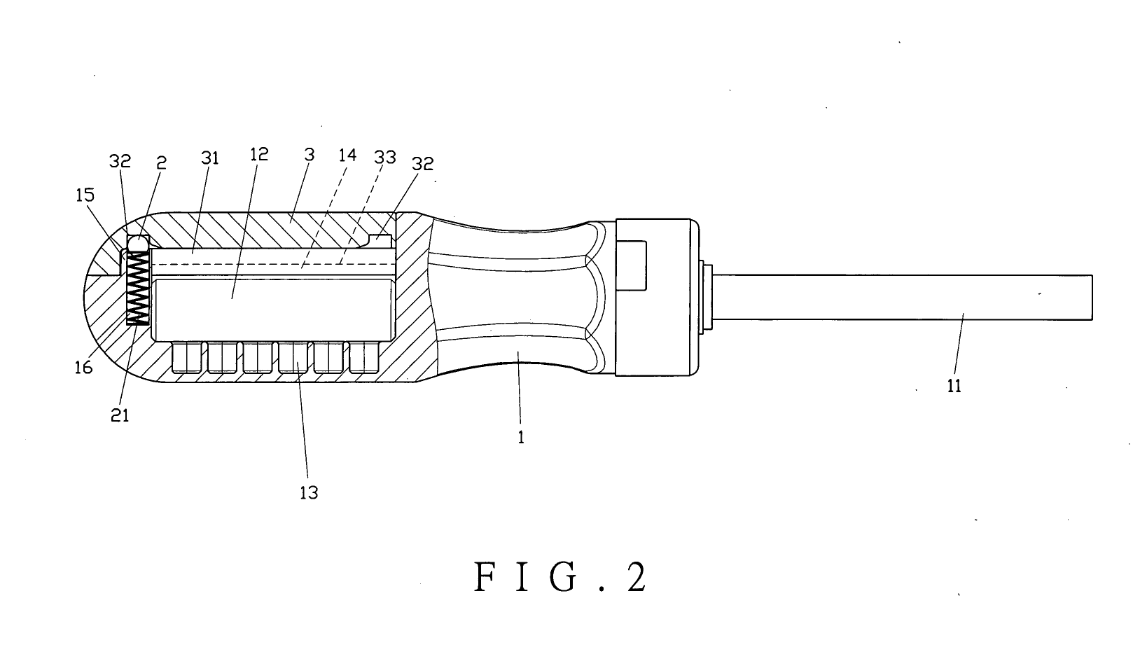

To assemble the present invention, as shown in FIG. 2, the engaging device 2 with the elastic element 21 is placed into the trough 16 of the locator 15 of the handle 1. The sliding cover 3 is slid onto the handle 1 by means of aligning the two sliding channels 33 with the two sliding strips 14 of the handle 1 so the compartment 12 is covered by the sliding cover 3. The locator 15 of the handle 1 protrudes into the sliding trough 31. The engaging device 2 is located in one of the locating holes 32.

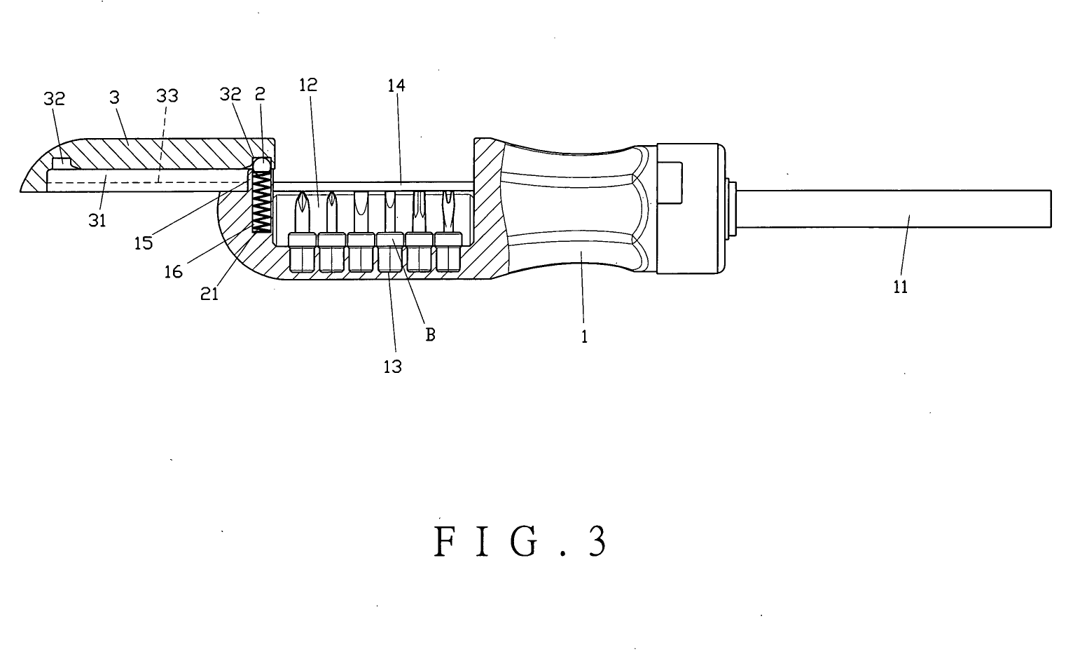

To operate the present invention, as shown in FIG. 3, the sliding cover 3 is pushed outwardly with respect to the handle 1 with the sliding channels 33 sliding along the sliding strips 14. The engaging device 2 will be retreated from the locating hole 32 when the sliding cover 3 reaches to the endmost of the handle 1. The engaging device 2 will locate in the other locating hole 32, which secures the sliding cover 3 in place. Thus the user may pick up or put back screw heads into the compartment 12, and then the sliding cover 3 may be pushed back to its original position.

I claim:

1. A screwdriver handle structure comprising:
a handle comprising a compartment, a pair of sliding sections at respective sides, a locator at one end with a trough therein;
an engaging device seating in said trough, said engaging device comprising an elastic element;
a sliding cover slid on said handle, said sliding cover comprising a sliding trough therein with a pair of locating holes at front and rear ends thereof, a pair of sliding sections at respective sides of said sliding trough to engage with said sliding sections of said handle.

2. The screwdriver handle structure, as recited in claim 1, wherein said sliding sections of said handle are sliding strips, and said sliding sections of said sliding cover are sliding channels.

3. The screwdriver handle structure, as recited in claim 1, wherein said compartment comprises recesses to store screw heads therein.
